(19) United States
(12) Patent Application Publication
(10) Pub. No.: US 2014/0136023 A1
(43) Pub. Date: May 15, 2014

(54) AUTOMATED CONTROL OF SPREADING SYSTEMS

(71) Applicant: Sensible Spreader Technologies, LLC, Dover, NH (US)

(72) Inventors: Andrew Jaccoma, Dover, NH (US); Christopher Dundorf, Barrington, NH (US); Donald Booth Spencer, Merrimack, NH (US); Christopher Rakowski, Somerville, MA (US)

(73) Assignee: Sensible Spreader Technologies, LLC, Dover, NH (US)

(21) Appl. No.: 14/080,142

(22) Filed: Nov. 14, 2013

Related U.S. Application Data
(60) Provisional application No. 61/857,017, filed on Jul. 22, 2013.
(60) Provisional application No. 61/726,207, filed on Nov. 14, 2012.

(51) Int. Cl. A01B 76/00; E01C 19/20; E01C 19/17

(52) U.S. Cl. CPC A01B 76/00; E01C 19/17; E01C 19/20
USPC 701/2; 701/50

(57) ABSTRACT

Described herein are devices and techniques for automating vehicle mounted spreading systems such as deicing systems for winter road maintenance vehicles and/or agricultural spreading systems by use of an electronic control system configured to operate a distribution element drive system.

### BACKGROUND

1. Field of the Invention

The present invention relates generally to vehicle mounted spreading systems and more particularly to a system for controlling vehicle mounted spreaders.

2. Discussion of Background information

In geographic locations that receive various amounts of snow fall each winter, keeping roads clear of ice and snow is a necessity. This is typically achieved by plowing roadways and then spreading deicing and/or abrasive materials (e.g., aggregates and/or liquid deicers) on road surfaces with spreaders. There are a large assortment of spreader and spreader controller manufacturers. Many spreaders are single aggregate, V-box and tailgate type spreaders. These systems are typically controlled manually by the driver, set at a single speed, or calibrated by the speed of the vehicle.

Chloride based deicers are the most widely used because of their availability and low cost, however their use has long lasting negative impacts on the areas in which they are used. Such deicers impact drinking water quality, aquatic life in rivers lakes and streams, and infrastructure (bridges in particular).

Typically, the primary means of regulating the amount of material that is applied to the road surface is the operator of the winter road maintenance vehicle. Such operators are required to focus on many tasks as they operate a plow vehicle, including but not limited to: driving in tedious driving conditions, navigating traffic, observing where the vehicle is on the roadway (including the surrounding environment), communication with a foreman (fleet coordinator or supervisor) and/or other operators, operating multiple plow controls, and/or operating multiple spreading system controls, all of which is compounded by the fact that operators typically work very long hours when spreading/plowing. Therefore, winter road maintainers (and plow truck operators in particular) have the propensity to over or under use deicing materials and/or fail to use the appropriate type of deicing material for the current geographic location.

Furthermore, even absent the operator's other responsibilities, because the operator is generally responsible for using manual throttling controls for activation and volumetric control of the spreading system (e.g., to increase or decrease application rates), it can be very difficult for the operator to provide precise, efficient, optimized application of deicing material. This problem is compounded in systems without mass flow feedback and/or systems with coarse application rate controls.

### SUMMARY OF THE INVENTION

It would be desirable to provide systems for automating vehicle mounted spreading systems such as deicing systems for winter road maintenance vehicles and/or agricultural spreading systems. Such automation can reduce stress and fatigue on operators and optimize material application, thereby reducing waste, improving cost-efficiency, protecting sensitive environments and infrastructure, and providing safer, more sustainable material spreading.

Described herein are devices and techniques for solving the problems, such as cost, inefficiency, driver distraction, and negative environmental impact, associated with traditional spreading systems. The systems for controlling spreading systems described herein electronically control distribution elements (e.g., conveyors, spinners, and/or sprayers) in response to vehicle status data acquired from various sensors (e.g., navigational systems, accelerometers, gyros, flow sensors, and/or pressure sensors). The systems may include one or more electronic controllers to operate one or more hydraulic valves of a hydraulic valve system, wherein the one or more hydraulic valves operate the distribution elements.

In one aspect, at least one embodiment described herein provides a system for controlling at least one distribution element of a vehicle mounted material spreader. The system includes a drive system operatively connected to the at least one distribution element. The system also includes an electronic control system configured to operate the drive system. The electronic control system includes at least one electronic controller for changing an operating condition of the drive system. The electronic control system also includes a navigational system for determining a geographical position of the vehicle. The electronic control system also includes at least one accelerometer for determining an acceleration or a deceleration of the vehicle. The electronic control system also includes at least one gyro for determining an attitude of the vehicle. The electronic control system also includes a means for determining a flow rate of a material distributed by the material spreader. The electronic control system also includes a processor configured to automatically instruct the at least one electronic controller to operate the drive system in response to at least one of the geographical position, the acceleration, the deceleration, the attitude, or the flow rate.

Any of the aspects and/or embodiments described herein can include one or more of the following embodiments. In some embodiments, the drive system is a valve system, an electric motor system, and/or a pump system operatively connected to the at least one distribution element. In some embodiments, the valve system includes at least one of a hydraulic valve, a pneumatic valve, or a solenoid valve. In some embodiments, the at least one distribution element is one or more of a conveyor belt, a spinner, an auger, a drag chain, an adjustable gate, a liquid power unit, a pump, and/or a sprayer. In some embodiments, the means for determining a flow rate is a flow sensor. In some embodiments, the means for determining a flow rate is a pressure sensor for determining a hydraulic or pneumatic pressure required to operate the distribution element at a desired speed, wherein an increase in the hydraulic or pneumatic pressure required to operate the conveyor element indicates an increase in the mass of the material being distributed by the at least one distribution element of the material spreader.

In some embodiments, the electronic control system includes an image recognition system configured to acquire a digital image, the processor configured to determine a lane position of the vehicle and/or a relative position of the vehicle from the acquired digital image. In some embodiments, the processor is configured to adjust at least one of a rotational speed, a broadcast width, or an orientation of the distribution element in response to the lane position and/or the relative position of the vehicle determined from the acquired digital image. In some embodiments, the electronic controller includes at least one of a microcontroller, a solenoid, a programmable logic controller, a servo, a field programmable gate array, or a piezoelectric actuator. In some embodiments, the electronic control system includes a mobile processing device, wherein the mobile processing device includes at least one of the navigational system, the accelerometer, the gyro, and/or the processor.

In some embodiments, the mobile processing is connected to a communications network for communicating a status of the vehicle mounted material spreader with a remote system. In some embodiments, the electronic control system further comprises a display operatively connected to the processor, the display configured to receive instructions from the processor for displaying an operational status of the vehicle mounted material spreader. In some embodiments, the system includes a memory for storing spreading guideline data, wherein the processor is configured to automatically instruct the at least one electronic controller to operate the drive system in response to the spreading guideline data. In some embodiments, the electronic controller is connected to a communications network for receiving electronic instructions and/or electronic data from a remote system.

### BRIEF DESCRIPTION OF THE DRAWINGS

One will better understand these and other features, aspects, and advantages of the present invention following a review of the description, appended claims, and accompanying drawings:

FIG. 1 is a diagram illustrating a system for controlling a vehicle mounted material spreader in accordance with various embodiments.

FIG. 2 is a cross-sectional view of a vehicle mounted spreading system in accordance with various embodiments.

FIG. 3A is a diagram illustrating variant geographical spreading requirements in accordance with various embodiments.

FIG. 3B is a table illustrating various spreading policy guidelines in accordance with various embodiments.

FIG. 4 is a diagram illustrating insufficient material distribution in accordance with various embodiments

FIGS. 5A-5C are diagrams illustrating various acceleration and deceleration conditions in accordance with various embodiments.

FIGS. 6A-6C are diagrams illustrating various vehicle orientation conditions in accordance with various embodiments.

FIG. 7 is a diagram illustrating the function of an image recognition system in accordance with various embodiments.

FIGS. 8A-8B are diagrams illustrating various historical spreading data overlays in accordance with various embodiments.

FIG. 8C is a diagram illustrating historical spreading data overlays applied to a map in accordance with various embodiments.

FIG. 9A is a diagram illustrating a remote fleet control system in accordance with various embodiments.

FIG. 9B is a diagram illustrating fleet status data overlays applied to a map in accordance with various embodiments.

FIG. 10 is a diagram illustrating a remote data collection system in accordance with various embodiments.

### DETAILED DESCRIPTION

Described herein are devices and techniques for solving the problems, such as cost, inefficiency, driver distraction, and negative environmental impact, associated with traditional spreading systems. The systems for controlling spreading systems described herein electronically control distribution elements (e.g., conveyors, spinners, and/or sprayers) in response to vehicle status data acquired from various sensors (e.g., navigational systems, accelerometers, gyros, flow sensors, and/or pressure sensors). The systems may include one or more electronic controllers to operate one or more hydraulic valves of a hydraulic valve system, wherein the one or more hydraulic valves operate the distribution elements.

While various exemplary embodiments described herein and illustrated by the figures are focused on particular applications of the technology relating to winter road maintenance vehicles, it will be apparent to one skilled in the art that the technology has utility in connection with agricultural spreading systems and/or any other vehicle mounted spreading system.

This patent application is related to U.S. Provisional Patent Application No. 61/762,207 and U.S. Provisional Patent Application No. 61/857,017, both of which are incorporated herein in their entirety.

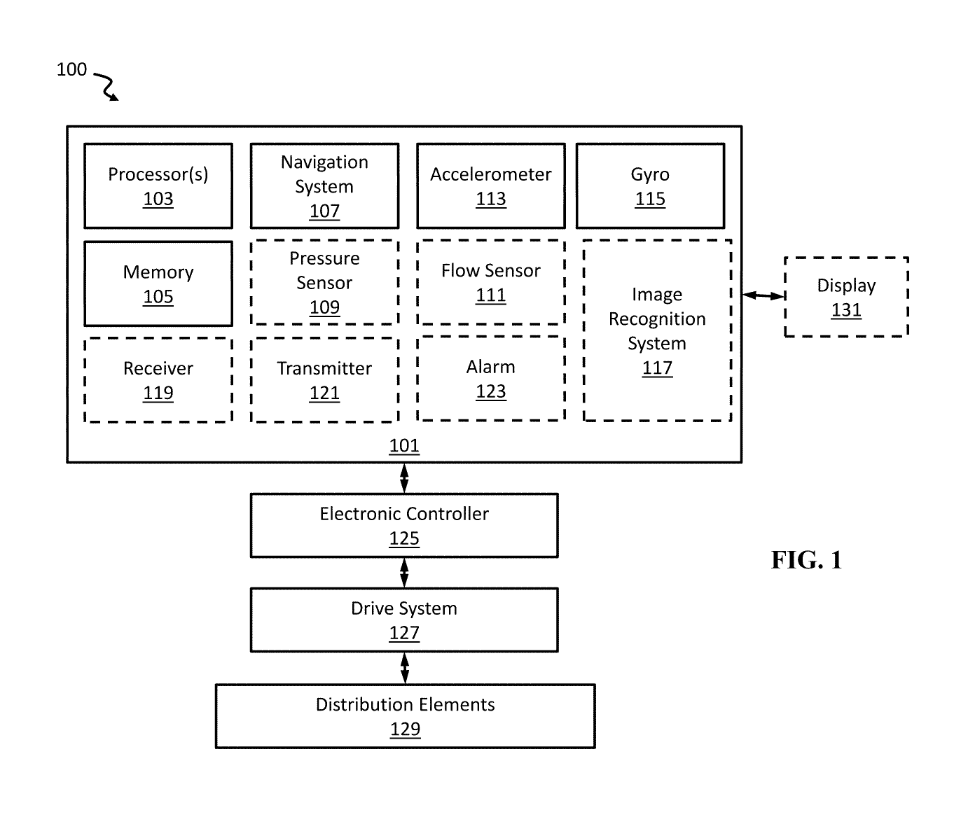

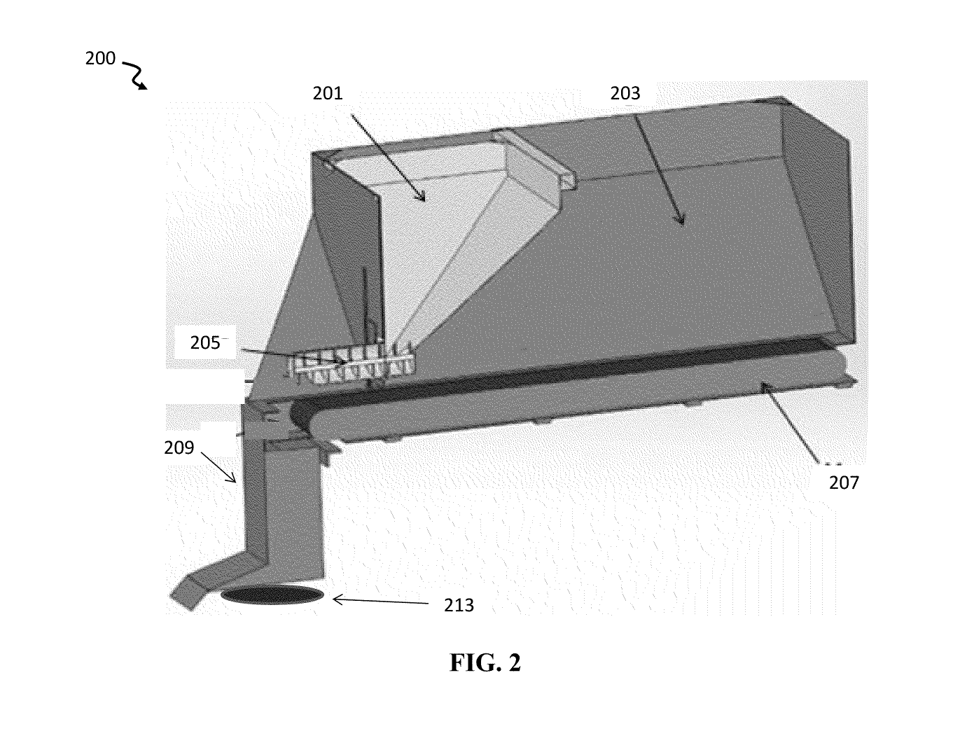

FIG. 2 illustrates an exemplary vehicle mounted spreading system 200 which can, in accordance with various embodiments, be operated by the system 100 illustrated in FIGS. 1 and 3-10 and described with greater detail below. As illustrated in FIG. 2, the exemplary vehicle mounted spreading system 200 can include a primary hopper 203 connected to a conveyor belt 207 for holding and distributing a first material, a sub hopper 201 connected to an auger 205 for holding and distributing a second material, a chute 209 for guiding the first and/or second material onto a spinner 213, and the spinner 213 for broadcasting the material onto a desired surface.

Referring now to FIG. 1, various embodiments of a system 100 for controlling at least one distribution element 129 of a vehicle mounted material spreader can include at least one distribution element 129 for distributing a material, a drive system 127 connected to an electronic controller 125 for operating the distribution elements, and an electronic control system 101 for instructing the electronic controller 125 to operate the drive system 127. The system 100 optionally includes a display 131 for displaying an operational status of the vehicle mounted material spreader. Materials can include, for example, a deicing aggregate, liquid deicer, fertilizer, seeds, any other winter road maintenance material, and/or any other agricultural material.

The at least one distribution element 129 can, in accordance with various embodiments, include any suitable device or system for distributing a material. Distribution elements 129 can include, for example but not limited to, a conveyor belt, a spinner, an auger, a drag chain, an adjustable gate, a liquid power unit, a pump, a sprayer, and/or any other suitable device. By way of example, the distribution elements 129 of the exemplary vehicle mounted spreading system illustrated by FIG. 2 include the conveyor belt 207, the auger 205, and the spinner 213.

The drive system 127 can, in accordance with various embodiments can be any suitable device or system for operating the distribution elements 129. Drive systems 127 can include, for example but not limited to, a valve system, an electric motor system, and/or a pump system. Valve systems, in accordance with various embodiments, can include hydraulic valve systems, pneumatic valve systems, and/or solenoid valve systems, wherein adjusting a pressure in one or more of the valves adjusts a power transmitted to and/or an operating speed of the distribution element(s) 129.

The electronic controller 125, in accordance with various embodiments, is configured to receive instructions from the electronic control system 101 and to operate the drive system 127 according to those instructions. Electronic controllers 125, in accordance with various embodiments, can include any suitable electronic control device or system, including for example, a microcontroller, a solenoid, a programmable logic controller, a servo, a field programmable gate array, and/or a piezoelectric actuator.

Operation of the drive system 127 by the electronic controller can include increasing or decreasing pressure in a valve system, increasing or decreasing electrical power delivered to an electric motor system, and/or increasing or decreasing a pump flow rate in a pump system. Such operation of the drive system affects the speed and load capabilities of the distribution elements, thereby resulting in an appropriate volume of material to be distributed by each distribution element 129 (e.g., auger 205 and/or conveyor 207), an appropriate broadcast width of the material (e.g., by adjusting a rotational speed of the spinner 213), and/or an appropriate directionality of the material being distributed (e.g., by angling and/or altering a position of the spinner 213).

The electronic control system 101 can include a navigational system 107 for determining a geographical position of the vehicle, at least one accelerometer 113 for determining an acceleration and/or deceleration of the vehicle, at least one gyro 115 for determining an attitude of the vehicle, a means for determining flow rate (e.g., pressure sensor 109 and/or flow sensor 111), and a processor 103 for automatically instructing the electronic controller 125 to operate the drive system 127 in response to a geographical position, an acceleration/deceleration, an attitude and/or the flow rate of the material(s). The electronic control system can also include a memory 105 for storing spreading guideline data, a receiver 119 and/or a transmitter 121 for communicating with a remote system, an image recognition system 117 for determining a relative position of the vehicle, and/or an alarm 123 for alerting a driver or other operator to an operating condition of concern.

It will be apparent in view of this disclosure that the electronic control system 101 and/or any component or combination of components thereof, in accordance with various embodiments can be implemented in an on-board system or a remote system. The on-board and/or remote systems can each include one or more computing devices. A computing device can include, for example, a computer, a computer with a browser device, a telephone, an IP phone, a mobile processing device, e.g., cellular phone, personal digital assistant (PDA) device, laptop computer, electronic mail device, and/or other communication devices. The browser device includes, for example, a computer, e.g., desktop computer, laptop computer, with a World Wide Web browser, e.g., Microsoft® Internet Explorer® available from Microsoft Corporation, Mozilla® Firefox available from Mozilla Corporation. The mobile processing device includes, for example, a Blackberry®, iPAD®, iPhone®, other smartphone device, cellular phone, personal digital assistant (PDA) device, laptop computer, electronic mail device, and/or other communication devices. In accordance with various embodiments, the remote system can include a cloud-based computing and/or storage/memory system.

In various embodiments an on-board system can include a mobile processing device having at least, for example, built-in accelerometers 113, gyros 115, processors 103, memory 105, receivers 119, transmitters 121, and/or displays 131. In such embodiments, the electronic control system 101 can be operated via a mobile “app” configured to coordinate each of the components of electronic control system 101.

Processors 103, in accordance with various embodiments, can include, but are not limited to, general and special purpose microprocessors, field programmable gate arrays (FPGA), application specific integrated circuits (ASIC), and/or any one or more processors of any kind of digital computer.

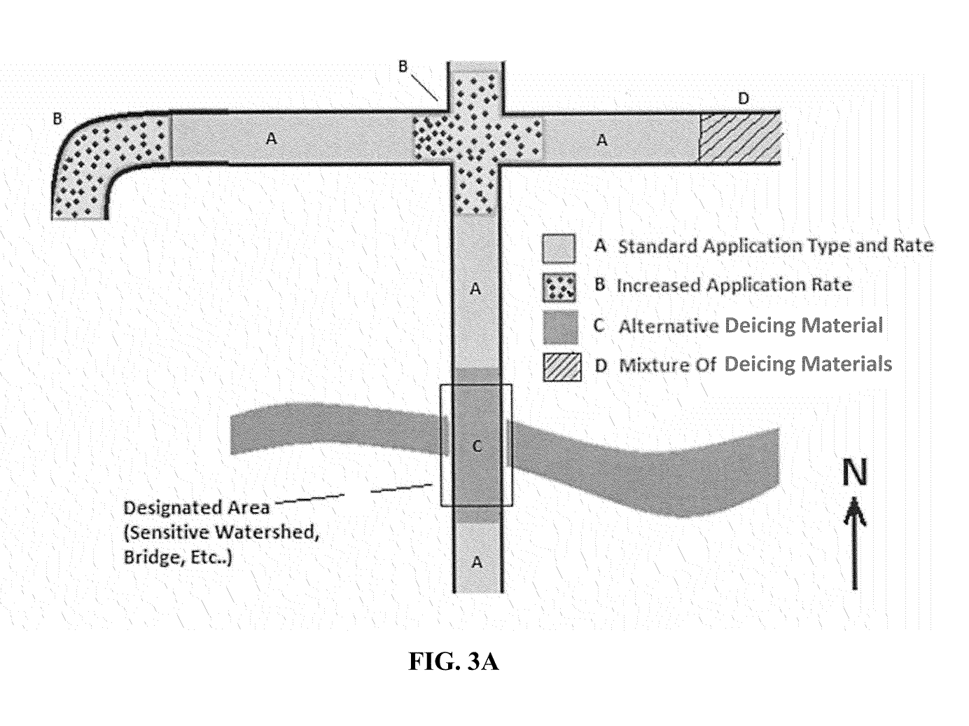

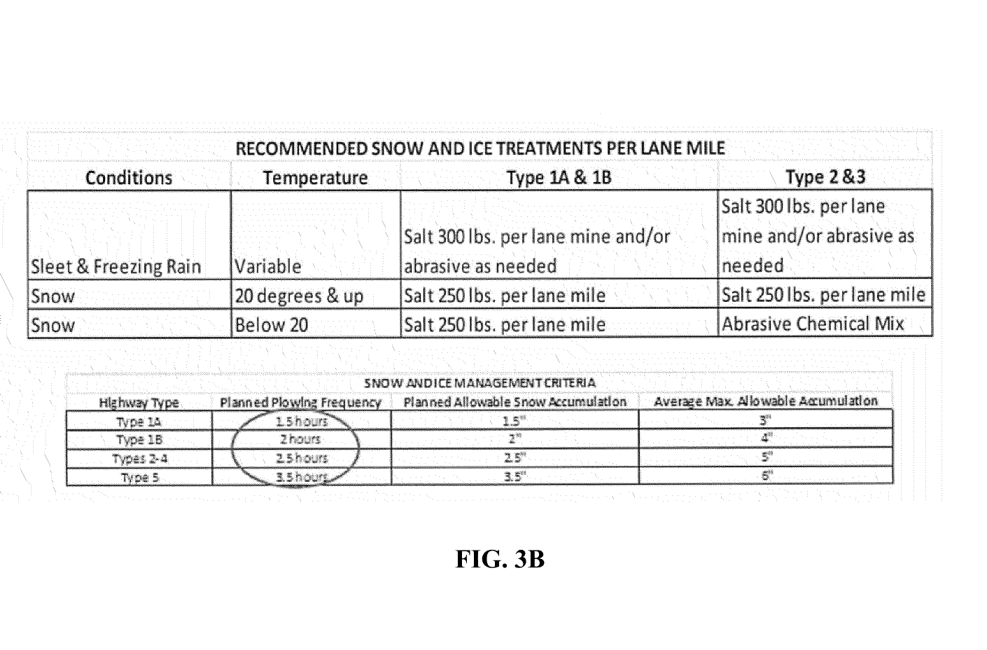

Memory 105, in accordance with various embodiments, can include, but is not limited to, read-only memory, random access memory (RAM), mass storage devices, e.g., magnetic, magneto-optical disks, or optical disks, EPROM, EEPROM, flash memory devices, magnetic disks, internal hard disks, removable disks, CD-ROM, and/or DVD-ROM disks. In accordance with various embodiments, memory 105 can also include a remote cloud storage system. The spreading guideline data can include, for example, application rates, material types, spreading policy data, geographic correlations associated with such data, historical spreading data, and/or any other relevant data. As shown in FIG. 3A, memory 105 can include data providing geographic correlations to spreading rates and desired material type. The data illustrated in FIG. 3A pertains to an exemplary winter road maintenance application and indicates that a standard material should be distributed at a standard rate in locations rated category A, that the application rate should be increased in locations (e.g., intersections or corners) rated category B, that sensitive areas, rated category C, should receive alternative materials, and that in areas rated category D, a mixture of materials is desirable. As shown in FIG. 3B, winter road maintenance or other spreading policy data can also be stored in memory 105.

Navigation system 107 can include any suitable navigation system, including for example, GPS systems, LORAN systems, cell-tower triangulation systems, Wi-Fi location systems, radio location systems, and/or inertial navigation systems. Navigation systems 107 can be used in conjunction with any other component of electronic control system 101 in order to determine an appropriate operating condition of the drive system. For example, processor 103 can compare geographical data from navigation system 107 with spreading guideline from memory 105 (e.g., as shown in FIGS. 3A-3B) in order to determine appropriate materials for distribution and appropriate distribution rates. The processor 103 can then automatically instruct the electronic controller 125 to operate the drive system(s) 127 accordingly.

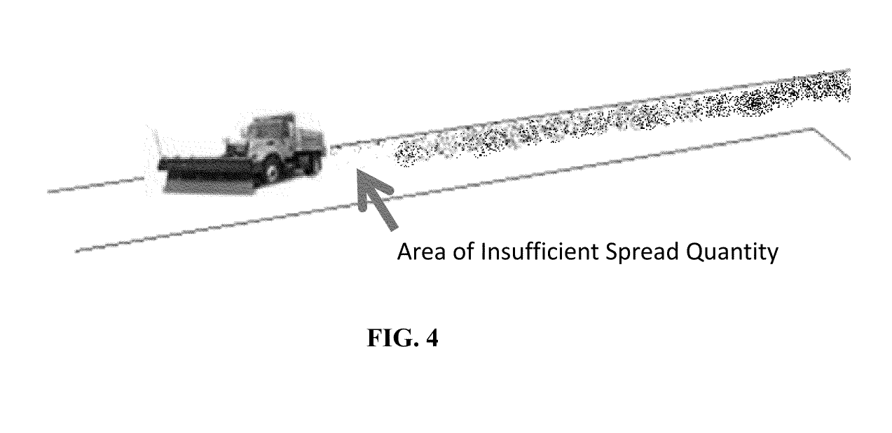

The means for determining a flow rate, in accordance with various embodiments, can be used to monitor the flow rate of material being distributed. The processor 103 can then instruct the electronic controller 125 to operate the drive system(s) 127 to cause an increase or decrease in flow rate as needed. Additionally, the means for determining flow rate can detect abnormal gaps in material flow or terminations of material flow (see FIG. 4), which can indicate tunneling (a condition where the material gets jammed in the storage component, e.g., primary and sub hoppers 2013, 201, resulting in lack of material near the distribution element 129) or a need to refill the spreading system with additional material. Upon detection of such events, the processor 103 can activate an optional alarm 123 (e.g., a visual alarm, such as a flashing light or indicator on optional display 131, or an auditory alarm).

The means for determining a flow rate, in accordance with various embodiments, can include one or more flow sensors 111 for measuring a flow rate of material being distributed. In the exemplary vehicle mounted spreading system 200 of FIG. 2, flow sensors 111 can be positioned at a terminal end of auger 205 to measure a flow rate of the second material from the sub hopper 201, at a terminal end of conveyor 207 to measure a flow rate of the first material from primary hopper 203, and/or in chute 209 to measure a combined flow rate of the first and second materials.

The means for determining a flow rate, in accordance with various embodiments, can alternatively or additionally include a pressure sensor 109. Pressure sensor 109 can be used to determine a hydraulic or pneumatic pressure required to operate the distribution element at a desired speed. In such embodiments, an increase in the hydraulic or pneumatic pressure required to operate the conveyor element indicates an increase in the mass of the material being distributed, i.e., indicating an increase in flow rate. A decrease in the hydraulic or pneumatic pressure required to operate the conveyor element indicates a decrease in the mass of the material being distributed, i.e., indicating a decrease in flow rate. An unexpected decrease in the required hydraulic or pneumatic pressure can, in accordance with various embodiments, indicate tunneling or the need for additional material as described above.

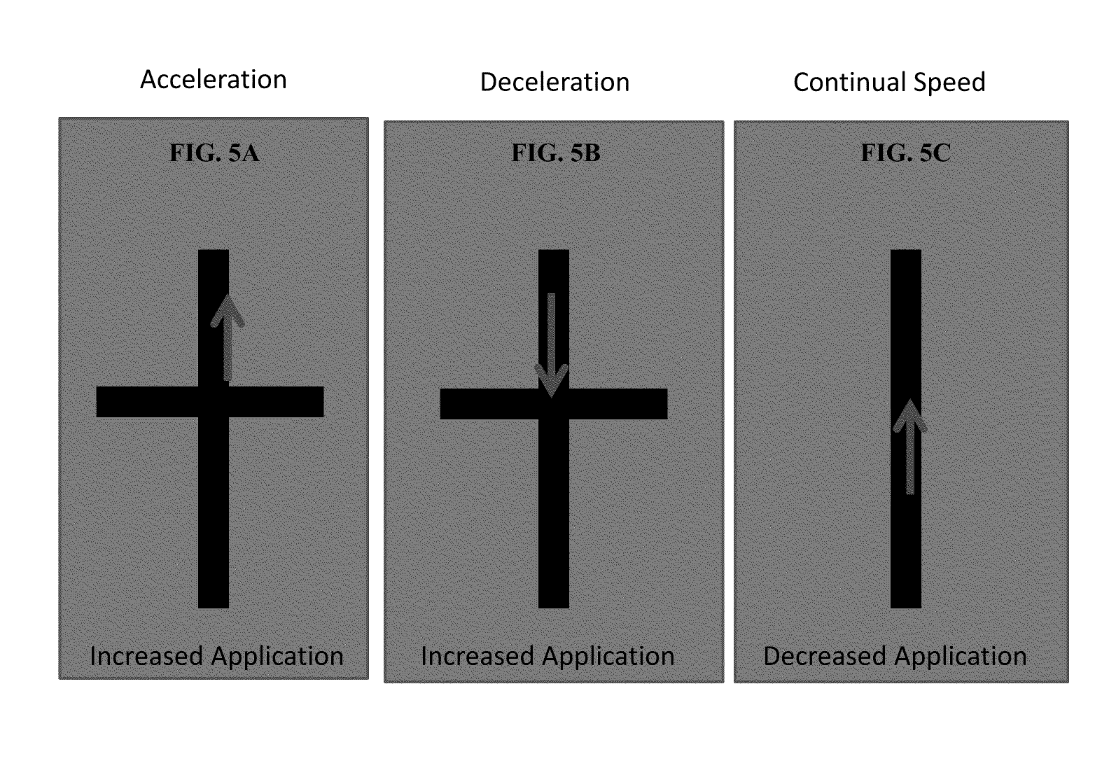

Accelerometer 113 can be used to detect acceleration and/or deceleration of the vehicle during spreading. In accordance with various embodiments, accelerometer 113 can used in conjunction with various other components of electronic control system 101 to dynamically adjust spreading quantities as needed. For example, as shown in FIGS. 5A-5C, if the accelerometer 113 indicates to the processor 103 that the vehicle is undergoing increased acceleration and/or deceleration, such as when departing or approaching an intersection, the processor 103 can instruct the electronic controller 125 to increase the base application rate. Conversely, if the accelerometer 113 indicates to the processor 103 that the vehicle is traveling at a constant speed, the processor 103 can instruct the electronic controller 125 to decrease the base application rate.

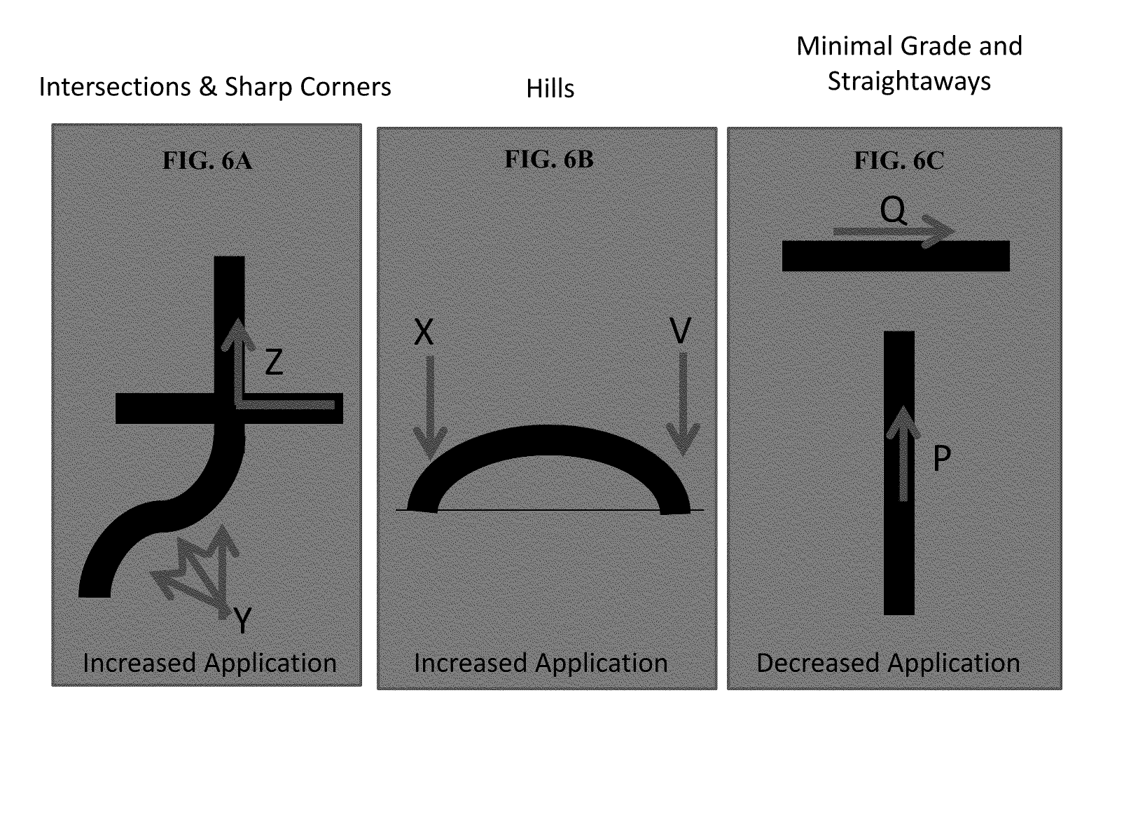

Gyro 115 can be used to detect changes in vehicle orientation during spreading. In accordance with various embodiments, gyro 115 can used in conjunction with various other components of electronic control system 101 to dynamically adjust spreading quantities as needed. For example, as shown in FIGS. 6A-6C, if the gyro 115 indicates to the processor 103 that the vehicle is changing orientation, such as when turning, ascending a hill, or descending a hill, the processor 103 can instruct the electronic controller 125 to increase the base application rate. Conversely, if the gyro 115 indicates to the processor 103 that the vehicle is traveling along a straight roadway with minimal grade, the processor 103 can instruct the electronic controller 125 to decrease the base application rate.

In accordance with various embodiments, a plurality of accelerometers 113 and gyros 115 can be combined to provide an inertial measurement unit, thereby advantageously enabling inertial navigation of the vehicle to augment and/or back up the primary navigation system 107.

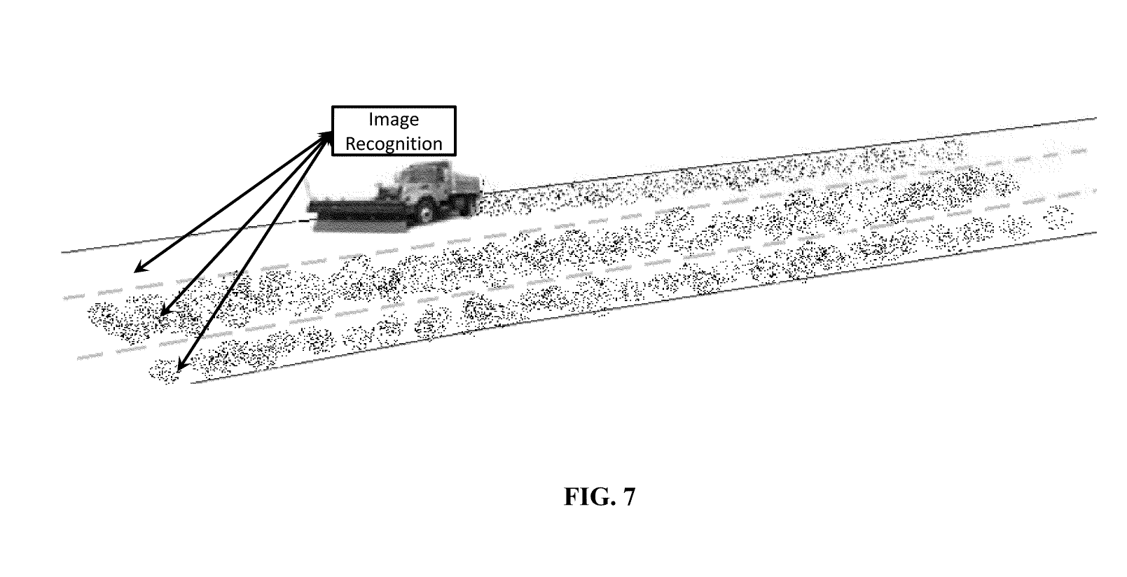

Image recognition system 117 can include, for example but without limitation, a digital camera, a digital video camera, and/or an infrared camera. In accordance with various embodiments, the image recognition system 117 advantageously augments the navigational system 107 and/or provides a backup means of navigating in the event the navigation system 107 fails. In accordance with various embodiments, the image recognition system 117 provides visual data to the processor 103, which then determines a lane position of the vehicle. This capability supplements a traditional navigation system 107 such as, for example, GPS or cell tower triangulation because such navigation systems 107 lack sufficient accuracy to determine lane position. Such embodiments therefore advantageously allow the electronic control system 101 to determine appropriate broadcast width and/or directionality of the material. The image recognition system can also be used in conjunction with other components of the electronic control system 101. For example, as shown in FIG. 7, the image recognition system 117 can determine that the vehicle is transiting the right lane and historical spreading data provided by the memory 105 indicates that the two lanes immediately to the left of the vehicle have already been treated. Therefore, the electronic control system 101 will instruct the spinner 213 to broadcast material at a single lane width, directly behind the vehicle.

The image recognition system 117 can also augment the navigation system 107 by providing more accurate data regarding a relative position of the vehicle. Using the example of FIG. 3A, a GPS navigation system may be inaccurate by several yards when determining where designated area C begins and ends. This could lead to excessive use of a more expensive material and/or could result in use of the incorrect material in a sensitive area. However, the image recognition system 117 could identify the presence of the designated area (e.g., by a landmark) and work with the GPS system to provide a more accurate determination of where the sensitive area C begins and ends. This feature advantageously allows the spreading system to insure that sensitive areas are protected while minimizing use of the more expensive alternative material.

In accordance with various embodiments, the image recognition system 117 can augment or replace outside weather data by including an infrared sensor to determine a temperature of the roadway, thereby insuring that appropriate types and quantities of material are being distributed.

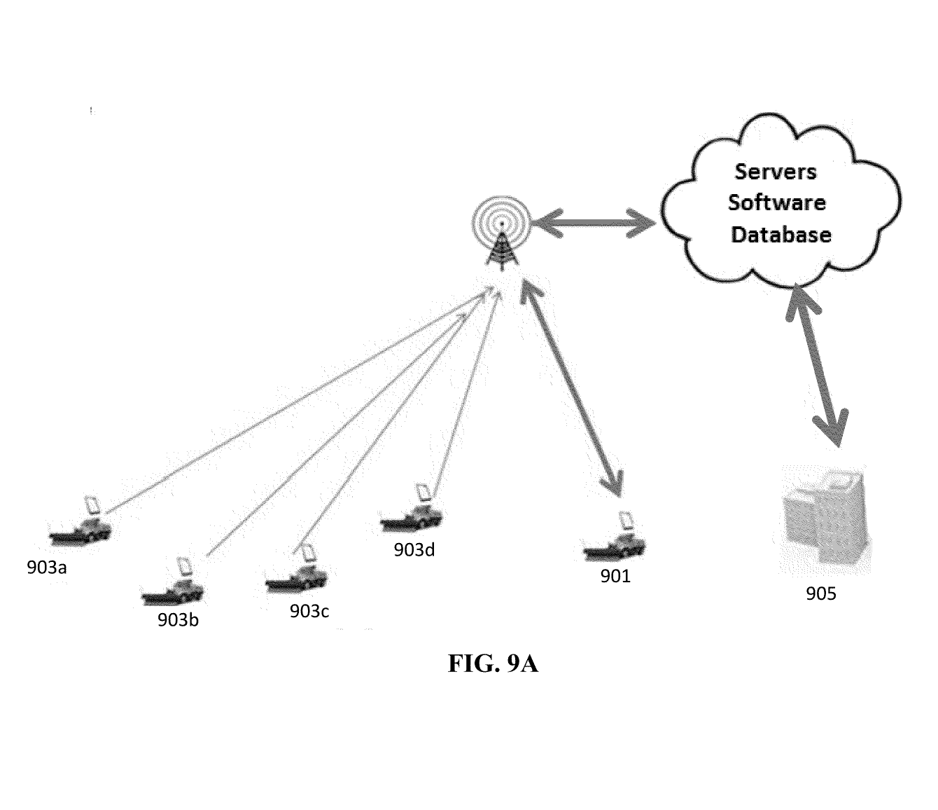

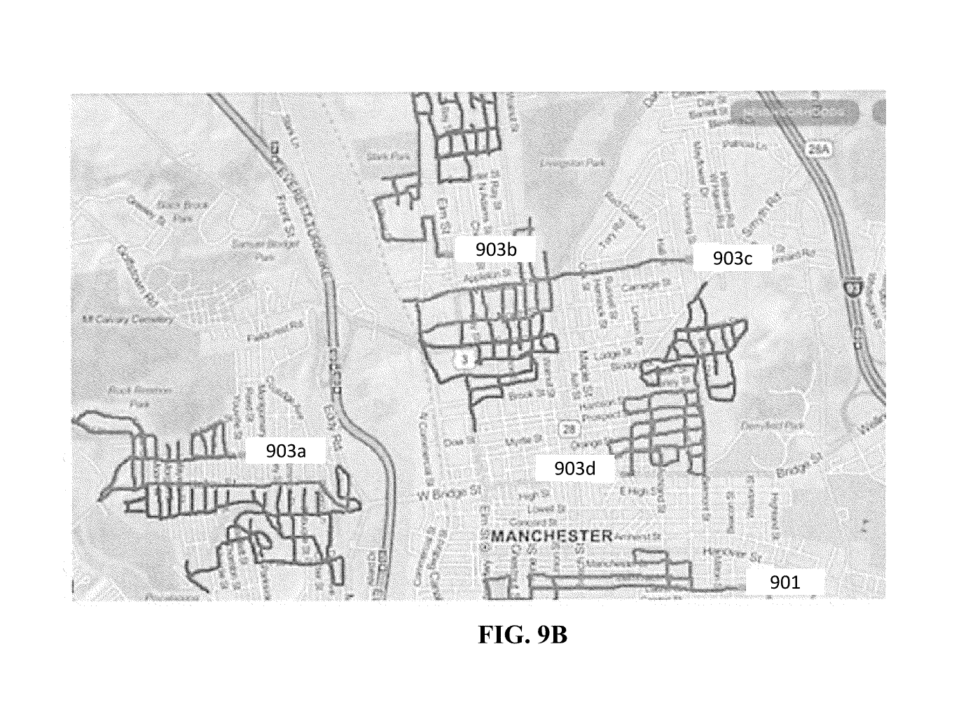

Transmitter 121 and receiver 119, in accordance with various embodiments, can be hardwired onto the vehicle and/or provided in a mobile processing device. As shown in FIG. 9A, transmitter 121 and receiver 119 can be used, in accordance with various embodiments, to provide communication between a vehicle 901, a remote control center 905, and/or other vehicles in a fleet 903a-d. In such embodiments, as shown in FIG. 9B, the display 131 can be configured to show a relative position of the vehicle 901 relative to the other vehicles in the fleet 903a-d. FIG. 9B also illustrates that the display 131 can provide indicators to show a recently traversed route of each vehicle 901, 903a-d so that the operators can avoid overlapping routes where possible and the electronic control system 101 can terminate the distribution of material where overlap is unavoidable, thereby eliminating redundant material distribution and wasted cost.

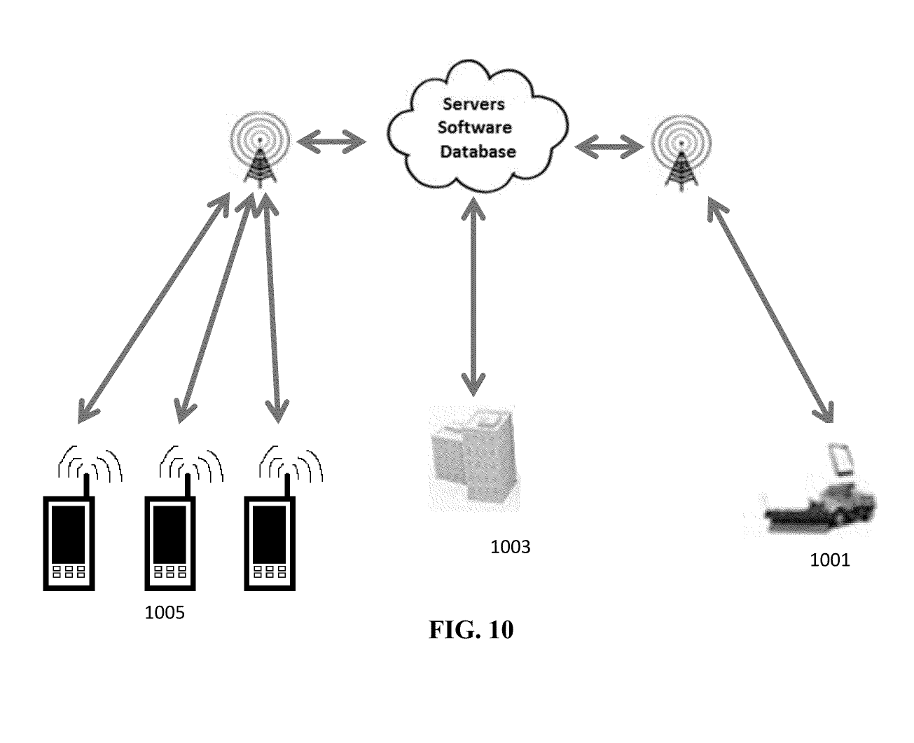

As shown in FIG. 10, transmitter 121 and receiver 119 can, in accordance with various embodiments, be used to provide communication between a vehicle 1001, a remote control center 1005, and external data sources 1005 (e.g., mobile processing devices located in a non-fleet vehicle, weather reporting systems, the internet, and/or any other external data source).

Display 131 can include, for example and without limitation, a cathode ray tube (CRT), a liquid crystal display (LCD), a light emitting diode (LED) display, and/or a touch screen). Display 131 can be used, in accordance with various embodiments, to receive instructions from electronic control system 101 for providing information to an operator. Such information can include, for example and without limitation, material flow rates, fleet status information (e.g., as shown in FIG. 9B), images from image recognition system 117, and/or navigational maps/data from navigation system 107.

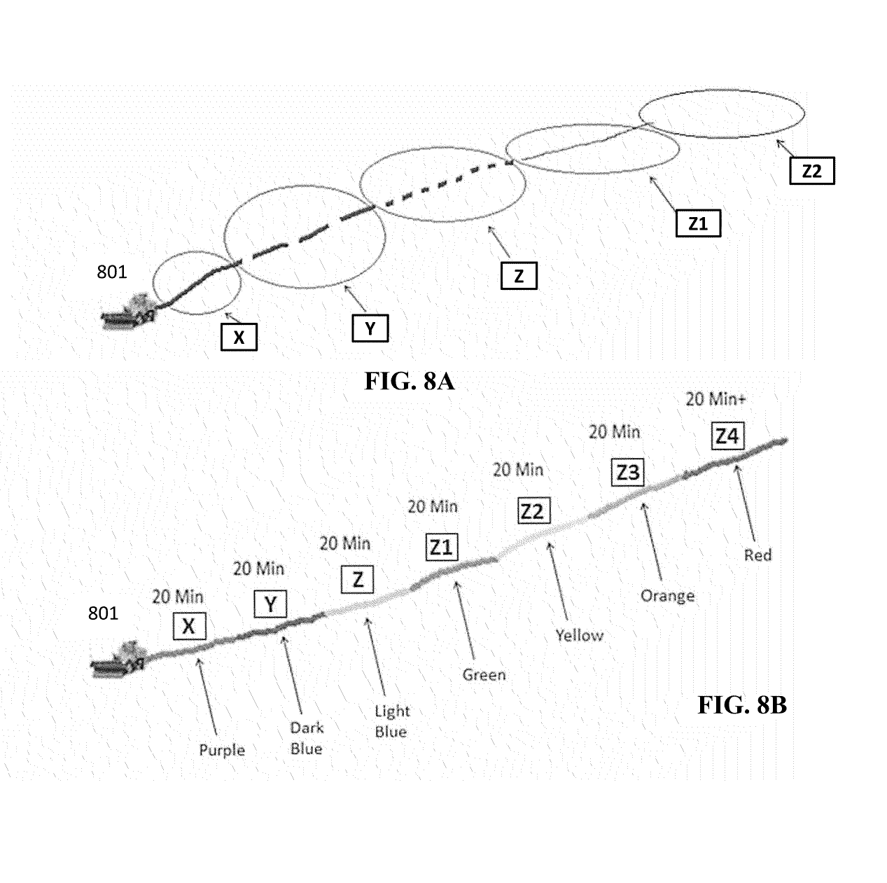

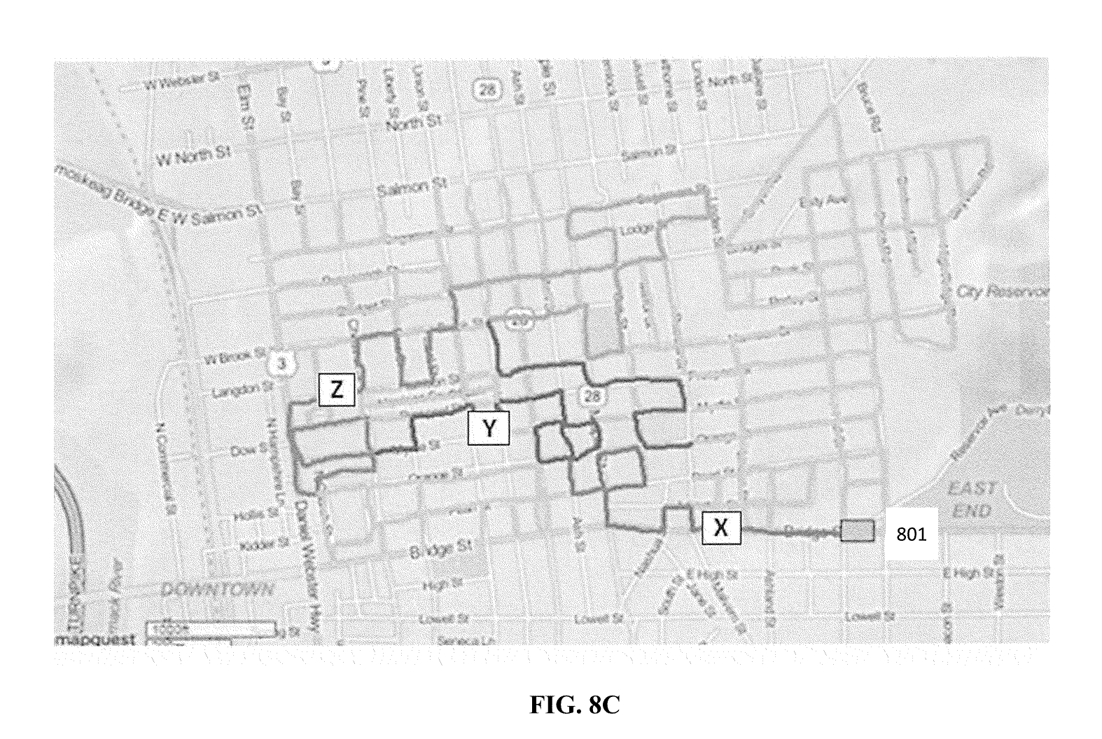

As shown in FIGS. 8A-8C, in accordance with various embodiments, the display 131 can be configured to show historical spreading data laid over the route traversed by the vehicle 801. The map has been omitted in FIGS. 8A-8B for clarity. In various embodiments illustrated by FIG. 8A, the display 131 uses different line weights and dash-patterns to indicate elapsed time. In various embodiments illustrated by FIGS. 8B and 8C, the display 131 uses different line colors (as labeled in FIG. 8B) to indicate elapsed time. In each of FIGS. 8A-8C, each particular line segment of the displayed line indicates a different historical time bin, where segments labeled X indicate that material has been applied within the previous 20 minutes, segments labeled Y indicate that material has been applied 20-40 minutes ago, segments labeled Z indicate that the material has been applied 40-60 minutes ago, etc. Accordingly, an operator can easily determine which areas of a route have been treated and which areas of the route need to be revisited.

Various embodiments of the above-described systems and methods may be implemented in digital electronic circuitry, in computer hardware, firmware, and/or software. The implementation can be as a computer program product (i.e., a computer program tangibly embodied in an information carrier). The implementation can, for example, be in a machine-readable storage device and/or in a propagated signal, for execution by, or to control the operation of, data processing apparatus. The implementation can, for example, be a programmable processor, a computer, and/or multiple computers.

A computer program can be written in any form of programming language, including compiled and/or interpreted languages, and the computer program can be deployed in any form, including as a stand-alone program or as a subroutine, element, and/or other unit suitable for use in a computing environment. A computer program can be deployed to be executed on one computer or on multiple computers at one site.

Method steps can be performed by one or more programmable processors executing a computer program to perform functions of the invention by operating on input data and generating output. Method steps can also be performed by, and an apparatus can be implemented as, special purpose logic circuitry. The circuitry can, for example, be a FPGA (field programmable gate array) and/or an ASIC (application specific integrated circuit). Modules, subroutines, and software agents can refer to portions of the computer program, the processor, the special circuitry, software, and/or hardware that implements that functionality.

Processors suitable for the execution of a computer program include, by way of example, both general and special purpose microprocessors, and any one or more processors of any kind of digital computer. Generally, a processor receives instructions and data from a read-only memory or a random access memory or both. The essential elements of a computer are a processor for executing instructions and one or more memory devices for storing instructions and data. Generally, a computer can be operatively coupled to receive data from and/or transfer data to one or more mass storage devices for storing data, e.g., magnetic, magneto-optical disks, or optical disks.

Data transmission and instructions can also occur over a communications network. Information carriers suitable for embodying computer program instructions and data include all forms of non-volatile memory, including by way of example semiconductor memory devices. The information carriers can, for example, be EPROM, EEPROM, flash memory devices, magnetic disks, internal hard disks, removable disks, magneto-optical disks, CD-ROM, and/or DVD-ROM disks. The processor and the memory can be supplemented by and/or incorporated in special purpose logic circuitry.

To provide for interaction with a user, the above described techniques can be implemented on a computer having a display device. The display device can, for example, be a cathode ray tube (CRT) and/or a liquid crystal display (LCD) monitor. The interaction with a user can, for example, be a display of information to the user and a keyboard and a pointing device, e.g., a mouse or a trackball, by which the user can provide input to the computer, e.g., interact with a user interface element. Other kinds of devices can be used to provide for interaction with a user. Other devices can, for example, be feedback provided to the user in any form of sensory feedback, e.g., visual feedback, auditory feedback, or tactile feedback. Input from the user can, for example, be received in any form, including acoustic, speech, and/or tactile input.

The above described techniques can be implemented in a distributed computing system that includes a back-end component. The back-end component can, for example, be a data server, a middleware component, and/or an application server. The above described techniques can be implemented in a distributing computing system that includes a front-end component. The front-end component can, for example, be a client computer having a graphical user interface, a Web browser through which a user can interact with an example implementation, and/or other graphical user interfaces for a transmitting device. The components of the system can be interconnected by any form or medium of digital data communication, e.g., a communication network. Examples of communication networks include a local area network (LAN), a wide area network (WAN), the Internet, wired networks, and/or wireless networks.

The system can include clients and servers. A client and a server are generally remote from each other and typically interact through a communication network. The relationship of client and server arises by virtue of computer programs running on the respective computers and having a client-server relationship to each other.

Packet-based networks can include, for example, the Internet, a carrier internet protocol (IP) network, e.g., local area network (LAN), wide area network (WAN), campus area network (CAN), metropolitan area network (MAN), home area network (HAN)), a private IP network, an IP private branch exchange (IPBX), a wireless network, e.g., radio access network (RAN), 802.11 network, 802.16 network, general packet radio service (GPRS) network, HiperLAN), and/or other packet-based networks. Circuit-based networks can include, for example, the public switched telephone network (PSTN), a private branch exchange (PBX), a wireless network, e.g., RAN, Bluetooth, code-division multiple access (CDMA) network, time division multiple access (TDMA) network, global system for mobile communications (GSM) network), and/or other circuit-based networks.

The computing system can also include one or more computing devices. A computing device can include, for example, a computer, a computer with a browser device, a telephone, an IP phone, a mobile device, e.g., cellular phone, personal digital assistant (PDA) device, laptop computer, electronic mail device, and/or other communication devices. The browser device includes, for example, a computer, e.g., desktop computer, laptop computer, with a World Wide Web browser, e.g., Microsoft® Internet Explorer® available from Microsoft Corporation, Mozilla® Firefox available from Mozilla Corporation. The mobile computing device includes, for example, a Blackberry®, iPAD®, iPhone® or other smartphone device.

Whereas many alterations and modifications of the disclosure will no doubt become apparent to a person of ordinary skill in the art after having read the foregoing description, it is to be understood that the particular embodiments shown and described by way of illustration are in no way intended to be considered limiting. Further, the subject matter has been described with reference to particular embodiments, but variations within the spirit and scope of the disclosure will occur to those skilled in the art. It is noted that the foregoing examples have been provided merely for the purpose of explanation and are in no way to be construed as limiting of the present disclosure.

While the present disclosure has been described with reference to example embodiments, it is understood that the words that have been used herein, are words of description and illustration, rather than words of limitation. Changes may be made, within the purview of the appended claims, as presently stated and as amended, without departing from the scope and spirit of the present disclosure in its aspects.

Although the present disclosure has been described herein with reference to particular means, materials and embodiments, the present disclosure is not intended to be limited to the particulars disclosed herein; rather, the present disclosure extends to all functionally equivalent structures, methods and uses, such as are within the scope of the appended claims.

What is claimed is:

1. A system for controlling at least one distribution element of a vehicle mounted material spreader comprising:
a drive system operatively connected to the at least one distribution element; and
an electronic control system configured to operate the drive system, the electronic control system including:
at least one electronic controller for changing an operating condition of the drive system;
a navigational system for determining a geographical position of the vehicle;
at least one accelerometer for determining an acceleration or a deceleration of the vehicle;
at least one gyro for determining an attitude of the vehicle;
a means for determining a flow rate of a material distributed by the material spreader, and;
a processor configured to automatically instruct the at least one electronic controller to operate the drive system in response to at least one of the geographical position, the acceleration, the deceleration, the attitude, or the flow rate.

2. The system of claim 1, wherein the drive system is a valve system, an electric motor system, and/or a pump system operatively connected to the at least one distribution element.

3. The system of claim 2, wherein the valve system includes at least one of a hydraulic valve, a pneumatic valve, or a solenoid valve.

4. The system of claim 1, wherein the at least one distribution element is one or more of a conveyor belt, a spinner, an auger, a drag chain, an adjustable gate, a liquid power unit, a pump, and/or a sprayer.

5. The system of claim 1, wherein the means for determining a flow rate is a flow sensor.

6. The system of claim 1, wherein the means for determining a flow rate is a pressure sensor for determining a hydraulic or pneumatic pressure required to operate the distribution element at a desired speed, wherein an increase in the hydraulic or pneumatic pressure required to operate the conveyor element indicates an increase in the mass of the material being distributed by the at least one distribution element of the material spreader.

7. The system of claim 1, wherein the electronic control system further comprises an image recognition system configured to acquire a digital image, the processor configured to determine a lane position of the vehicle and/or a relative position of the vehicle from the acquired digital image.

8. The system of claim 5, wherein the processor is configured to adjust at least one of a rotational speed, a broadcast width, or an orientation of the distribution element in response to the lane position and/or the relative position of the vehicle determined from the acquired digital image.

9. The system of claim 1, wherein the electronic controller includes at least one of a microcontroller, a solenoid, a programmable logic controller, a servo, a field programmable gate array, or a piezoelectric actuator.

10. The system of claim 1, wherein the electronic control system includes a mobile processing device, wherein the mobile processing device includes at least one of the navigational system, the accelerometer, the gyro, and/or the processor.

11. The system of claim 10, wherein the mobile processing is connected to a communications network for communicating a status of the vehicle mounted material spreader with a remote system.

12. The system of claim 1, wherein the electronic control system further comprises a display operatively connected to the processor, the display configured to receive instructions from the processor for displaying an operational status of the vehicle mounted material spreader.

13. The system of claim 1, further comprising a memory for storing spreading guideline data, wherein the processor is configured to automatically instruct the at least one electronic controller to operate the drive system in response to the spreading guideline data.

14. The system of claim 1, wherein the electronic controller is connected to a communications network for receiving electronic instructions and/or electronic data from a remote system.
